(19) United States
(12) Patent Application Publication
(10) Pub. No.: US 2026/0342851 A1
(43) Pub. Date: Oct. 29, 2026

(54) Honeycomb defense network with DDoS traceback and countermeasures

(71) Applicant: Akamai Technologies, Inc., Cambridge, MA (US)

(72) Inventor: Nitin Singla, Panchkula (IN)

(21) Appl. No.: 19/192,422

(22) Filed: Apr. 29, 2025

(51) Int. Cl. H04L 9/40

(52) U.S. Cl. CPC H04L 63/1491; H04L 63/1458

(57) ABSTRACT

A honeypot defense network comprises a network of honeypot servers disguised as legitimate attack targets. Preferably, these servers are associated with overlay network edge/compute machines, thereby providing potential worldwide strategic placement. The honeypots are designed to mimic vulnerabilities commonly exploited in DDoS attacks, actively luring attackers to waste their resources. Analysis tools with the honeypot(s) fingerprint attack traffic, e.g., based on its unique characteristics, origin points, and the like. Local honeypots create custom attack reports that are then delivered to and correlated by a central server infrastructure, which correlates attack fingerprints across the network, thereby enabling the system to provide a traceback to identify the source network or compromised devices that are orchestrating the attack. Based on this information, the central server implements or causes to be implemented a set of distributed countermeasures to provide a proactive approach to DDoS detection, mitigation and protection.

### BACKGROUND

This application relates generally to protecting websites and mobile applications (apps) from automated attacks by scripts or bots.

Distributed computer systems are well-known in the prior art. One such distributed computer system is a “content delivery network” (CDN) or “overlay network” that is operated and managed by a service provider. The service provider typically provides the content delivery service on behalf of third parties (customers) who use the service provider's shared infrastructure. A distributed system of this type typically refers to a collection of autonomous computers linked by a network or networks, together with the software, systems, protocols and techniques designed to facilitate various services, such as content delivery, web application acceleration, or other support of outsourced origin site infrastructure. A CDN service provider typically provides service delivery through digital properties (such as a website), which are provisioned in a customer portal and then deployed to the network. A digital property typically is bound to one or more edge configurations that allow the service provider to account for traffic and bill its customer.

It is known to provide a JavaScript-based technology to fingerprint clients and collect telemetry to evaluate end user behavior and to differentiate bots from humans. A commercial service of this type is available from Akamai Technologies, Inc. of Cambridge, Massachusetts. While bot detection systems such as described above provide significant advantages, detection of automated attacks or bots is difficult because they are constantly evolving and adapting to bypass detection algorithms. Detections based upon telemetry are also vulnerable to improved synthetic telemetry from bots.

In computer terminology, a honeypot is a computer security mechanism set to detect, deflect, or, in some manner, counteract attempts at unauthorized use of information systems. Generally, a honeypot consists of data (for example, in a network site) that appears to be a legitimate part of the site which contains information or resources of value to attackers. It is actually isolated, monitored, and capable of blocking or analyzing the attackers. The main use for this network decoy is to distract potential attackers from more important information and machines on the real network, learn about the forms of attacks they can suffer, and examine such attacks during and after the exploitation of a honeypot. It also provides a way to prevent and see vulnerabilities in a specific network system. More generally, a honeypot is a decoy used to protect a network from present or future attacks.

DDoS (Distributed Denial of Service) attacks are a constant threat to businesses and organizations, delaying service performance or shutting down websites entirely. DDoS mitigation is a set of network management techniques and/or tools for resisting or mitigating the impact of such attacks on networks attached to the Internet by protecting the target and relay networks. Typically, DDoS mitigation works by identifying baseline conditions for network traffic by analyzing “traffic patterns” to allow threat detection and alerting. DDoS mitigation also requires identifying incoming traffic to separate human traffic from human-like bots and hijacked web browsers. Usually, this process involves comparing signatures and examining different attributes of the traffic, including IP addresses, cookie variations, HTTP headers, and browser fingerprints. After the attack is detected, filtering is applied. Filtering can be done through anti-DDoS technology like connection tracking, IP reputation lists, deep packet inspection, blacklisting/whitelisting, or rate limiting. One highly-advantageous approach to DDoS detection and mitigation is to pass network traffic addressed to a potential target network through high-capacity networks, with “traffic scrubbing” filters. A well-known technique of this type, known as Akamai® Prolexic®, is available as a commercial service. Other methods to prevent DDoS attacks can be implemented, such as on-premises and/or cloud-based solution providers. On-premises mitigation technology (most commonly a hardware device) is often placed in front of the network. This limits the maximum bandwidth available to what is provided by the Internet service provider. Other common methods involve hybrid solutions, by combining on-premises filtering with cloud-based solutions.

Current DDoS mitigation solutions primarily focus on absorbing attack traffic, which can be expensive and does not necessarily address the root cause of the attack. Moreover, many current approaches have difficulty in identifying and then neutralizing the source of a DDoS attack. This is often quite challenging, primarily due to the distributed nature of the attack traffic. As a consequence, attackers can continue to launch attacks with relative impunity.

While these known technologies and techniques provide advantages, there remains a need to provide advanced techniques to protect website and web applications.

### SUMMARY

The techniques herein augment an overlay network to include a honeypot-based defense network that is geographically-distributed across edge servers of the overlay, and that leverages centralized attack detection and mitigation based on the telemetry collected from the distributed edge servers. The approach herein provides for a honeycomb defense network with Distributed Denial of Service (DDoS) attack traceback and countermeasures that provides for enhanced attack mitigation for network attacks. The solution not only mitigates DDoS attacks, but it also disrupts and potentially disables the attack source, thereby improving overall security posture and deferring future attacks.

The honeypot defense network comprises a network of honeypot servers disguised as legitimate targets (for attack). Preferably, these servers are associated with overlay network edge/compute machines, thereby providing potential worldwide strategic placement. The honeypots are designed to mimic vulnerabilities commonly exploited in DDoS attacks, actively luring attackers to waste their resources. Local honeypots create custom attack reports that are then correlated by the central server infrastructure, which correlates attack fingerprints across the network, thereby enabling the system to provide a traceback to identify the source network or compromised devices that are orchestrating the attack. Based on this information, the central server implements or causes to be implemented a set of distributed countermeasures, e.g., blackhole-ing IP addresses, disrupting the botnets at the source, and so forth, to provide a proactive approach to DDoS detection, mitigation and protection.

The foregoing has outlined some of the more pertinent features of the disclosed subject matter. These features should be construed to be merely illustrative. Many other beneficial results can be attained by applying the disclosed subject matter in a different manner or by modifying the subject matter as will be described

### BRIEF DESCRIPTION OF DRAWINGS

For a more complete understanding of the subject matter and the advantages thereof, reference is now made to the following descriptions taken in conjunction with the accompanying drawings, in which:

FIG. 1 is a distributed computer system in which the techniques of this disclosure may be practiced;

FIG. 2 depicts a representative machine architecture that supports and executes an edge server at which the techniques of this disclosure may be initiated;

FIG. 3 depicts a honeypot data capture (packet inspection) and analysis workflow that is implemented in an edge/compute machine according to this disclosure;

FIG. 4 depicts several high level operations of a central server of a honeycomb defense network of this disclosure;

FIG. 5 depicts a central server cross-correlation fingerprint analysis operation to identify the attack;

FIG. 6 depicts a central server traceback analysis function to identify an attack source;

FIG. 7 depicts a process flow of a distributed countermeasure technique implemented in the honeycomb defense network of this disclosure;

FIGS. 8A-8B depict a representative pseudocode implementation of the local honeypot data collection and pre-processing workflow;

FIG. 9 depicts a representative pseudocode implementation of the fingerprint generation at the central server;

FIG. 10 depicts a representative pseudocode implementation of the fingerprint cross-correlation analysis at the central server; and

FIG. 11 depicts a representative pseudocode implementation of the traceback and countermeasure selection at the central server.

### DETAILED DESCRIPTION

### Operating Environment

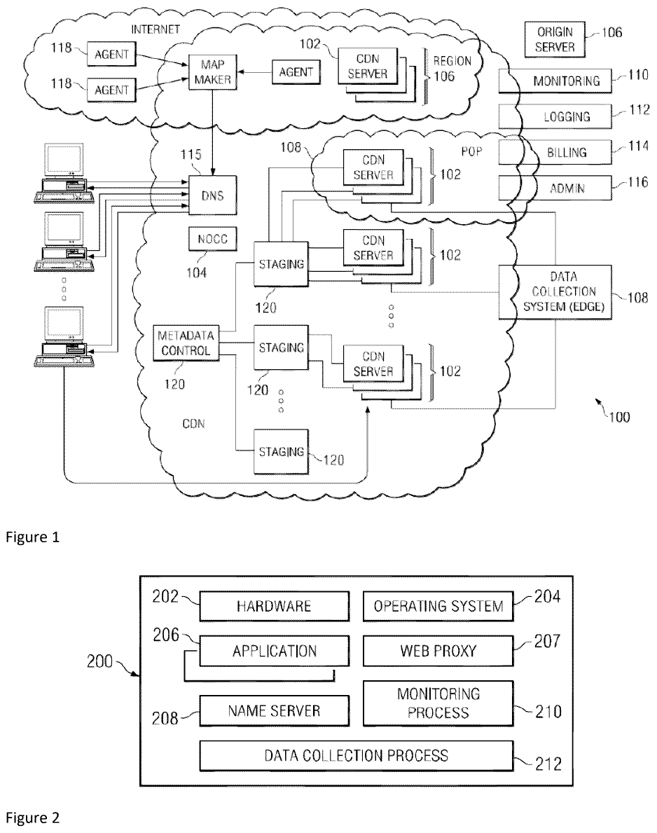

In a known system, such as shown in FIG. 1, a distributed computer system 100 is configured as a content delivery network (CDN) and is assumed to have a set of machines 102a-n distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to “edge” servers. Typically, content providers offload their content delivery by aliasing (e.g., by a DNS CNAME) given content provider domains or sub-domains to domains that are managed by the service provider's authoritative domain name service. End users that desire the content are directed to the distributed computer system to obtain that content more reliably and efficiently. Although not shown in detail, the distributed computer system may also include other infrastructure, such as a distributed data collection system 108 that collects usage and other data from the edge servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

As illustrated in FIG. 2, a given machine 200 comprises commodity hardware 202 running an operating system kernel (such as Linux or variant) 204 that supports one or more applications 206a-n. To facilitate content delivery services, for example, given machines typically run a set of applications, such as an HTTP proxy 207 (sometimes referred to as a “global host” process), a name server 208, a local monitoring process 210, a distributed data collection process 212, and the like.

A CDN edge server is configured to provide one or more extended content delivery features, preferably on a domain-specific, customer-specific basis, preferably using configuration files that are distributed to the edge servers using a configuration system. A given configuration file preferably is XML-based and includes a set of content handling rules and directives that facilitate one or more advanced content handling features. The configuration file may be delivered to the CDN edge server via the data transport mechanism. U.S. Pat. No. 7,111,057 illustrates a useful infrastructure for delivering and managing edge server content control information, and this and other edge server control information can be provisioned by the CDN service provider itself, or (via an extranet or the like) the content provider customer who operates the origin server.

The CDN may provide secure content delivery among a client browser, edge server and customer origin server. Secure content delivery enforces SSL- or TLS-based links between the client and the edge server process, on the one hand, and between the edge server process and an origin server process, on the other hand. This enables an SSL-protected web page and/or components thereof to be delivered via the edge server.

As an overlay, the CDN resources may be used to facilitate wide area network (WAN) acceleration services between enterprise data centers (which may be privately-managed) and third party software-as-a-service (SaaS) providers.

In a typical operation, a content provider identifies a content provider domain or sub-domain that it desires to have served by the CDN. The CDN service provider associates (e.g., via a canonical name, or CNAME) the content provider domain with an edge network (CDN) hostname, and the CDN provider then provides that edge network hostname to the content provider. When a DNS query to the content provider domain or sub-domain is received at the content provider's domain name servers, those servers respond by returning the edge network hostname. The edge network hostname points to the CDN, and that edge network hostname is then resolved through the CDN name service. To that end, the CDN name service returns one or more IP addresses. The requesting client browser then makes a content request (e.g., via HTTP or HTTPS) to an edge server associated with the IP address. The request includes a host header that includes the original content provider domain or sub-domain. Upon receipt of the request with the host header, the edge server checks its configuration file to determine whether the content domain or sub-domain requested is actually being handled by the CDN. If so, the edge server applies its content handling rules and directives for that domain or sub-domain as specified in the configuration. These content handling rules and directives may be located within an XML-based “metadata” configuration file.

More generally, the techniques described above are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines. The functionality may be provided as a service, e.g., as a SaaS solution.

Because the above-described CDN infrastructure (or “edge platform”) is shared by multiple third parties, it is sometimes referred to herein as a multi-tenant shared infrastructure. The CDN processes may be located at nodes that are publicly-routable on the Internet, within or adjacent nodes that are located in mobile networks, in or adjacent enterprise-based private networks, or in any combination thereof.

As used herein, an “edge server” refers to a CDN (overlay network) edge machine or server process used thereon. In the above-described context, a “region” typically is a set of edge servers or machines that are co-located with one another. More formally, a “region” or “cluster” typically is a collection of machines in a single location within a given region share equivalent front-end network connectivity and also share a local back-end network. A set of such regions and associated network infrastructure (e.g., within a metropolitan area or “metro”) which shares connectivity to the Internet is sometimes referred to herein as an Equivalence-Class-Of-Region (“ECOR”). There may be multiple ECORs in any given city (although there may be cases where an ECOR spans physical nearby buildings, such as with DWDM interconnects).

The edge platform as described is a deployed network designed to manage large numbers of distributed servers in a distributed fashion. To this end, and in one non-limiting embodiment, the platform leverages an underlying Linux-based operating system (OS) (e.g., a Linux kernel version that is Ubuntu-based). A Linux kernel version of this type (sometimes referred to herein as Linux Server Install (LSI)) may have one or more supporting services such as log aggregation, data aggregation and query reporting, secret management, and the like. Using the LSI and its related services, the system provides for: deploying and managing servers at scale; role-based and standards-compliant remote access control and audit functionality; a secret management system for distributing key materials; a Network Operations Control Center (NOCC) for tooling and expertise managing systems; a platform that incorporates ways to distribute critical control information with multiple safety features built-in, and techniques for keeping server BIOS and firmware up-to-date. The LSI is readily patched and features can be added thereto as needed.

The above-described network may also support compute resources. As is known, cloud computing is a model of service delivery for enabling on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). Typically, the cloud computing environment has a set of high level functional components that include a front end identity manager, a business support services (BSS) function component, an operational support services (OSS) function component, and the compute cloud components themselves.

A representative cloud computing infrastructure is implemented in a data center operated by a virtual machine (VM) hosting provider. A representative provider is Linode®, now owned by Akamai Technologies, Inc., of Cambridge, Massachusetts. In this infrastructure, a “host” refers to a bare-metal machine running software. A “compute host” is a machine that manages virtual machines VMs and typically runs associated administrative software for a cloud compute infrastructure. A “guest VM” is a virtual machine running on a compute host, and it may be a customer VM or an infrastructure VM. A “datacenter” (CD) typically is a customer-facing abstraction for cloud compute infrastructure, typically a cluster of guest VMs.

Virtual machine provisioning and management may be configured in one or more edge sites hosted within overlay network (e.g., CDN) regions and ECORs. More formally, the overlay network may provide a Generalized Edge Compute (GEC) capability that includes the notion of migrating compute instances out of a core site (e.g., a datacenter) and into locations within the overlay network edge, e.g., in edge access networks including, without limitation, those networks in metropolitan areas, in emerging markets, and the like. To this end, the GEC comprises a host engine running on overlay network edge hardware and software (e.g., LSI) for the purposes of supporting generalized compute workloads. The term “generalized” in this context implies both compute that is not tied to the delivery of objects through a CDN, as well as software written in any programming language that runs within the context of a virtual machine.

Deploying compute into an edge platform in this manner also takes advantage of existing operational tools, processes, and observability—enabling developers to innovate across the entire continuum of compute, providing a consistent experience from centralized cloud to distributed edge.

Honeycomb Defense Network with DDoS Traceback and Countermeasures

With the above as background, the technique of this disclosure is now described by way of example embodiment. According to the disclosure, the above-described and depicted overlay network (e.g., a CDN) is augmented to include an additional network, which is referred to herein as a honeycomb defense network. As used herein, the honeycomb defense network comprises a set of machines, processes, programs, and data that together augment the overlay network and its services to provide additional Distributed Denial of Service (DDoS) attack detection and mitigation. In this approach, overlay network edge servers (e.g., such as an edge machine depicted in FIG. 2) are fitted with a honeypot process that executes locally in association with the edge machine. The process typically is implemented as computer program code executed in a processor of a physical machine. The process also may be executed in a virtual machine supported on a hypervisor running in a compute instance. Generalizing, the honeypot process may be integrated in the edge server machine, or it may be executed as a separate process within a physical or virtual machine associated with the edge server machine. There may be a honeypot process associated with each CDN edge server within a given operating region (as described in FIG. 1), or a honeypot process executed in associated with a group of such edge machines.

The distributed set of honeypot processes configured as described above comprise honeypots that are designed to mimic vulnerabilities commonly exploited in DDoS attacks, actively luring attackers to waste their resources. These vulnerabilities include, without limitation, network protocol vulnerabilities (that attempt to exploit the way TCP/IP protocols handle connections, e.g., by sending a SYN flood, or a UDP flood), application layer vulnerabilities (that attempt to exploit weaknesses in web application protocols like HTTP, HTTPS, and SMTP, and wherein the attack floods the server with excessive requests that consume processing power and disrupt service), DNS amplification (that attempt to exploit vulnerable DNS servers by sending requests with spoofed IP addresses), weak security configurations (that attempt to exploit improperly configured web servers, firewalls, and load balancers), smurf attacks (that attempt to exploit the ICMP protocol by sending spoofed ping requests to a network's broadcast address, causing multiple devices to respond and flood the target), reflective attacks (sending traffic to servers like NTP or SNMP with a spoofed IP address, causing the servers to send large responses to the victim, amplifying the attack), and the like. The above examples are not meant to be limiting, but the notion here is that the honeypot is configured to lure the attacker in (so that the attack can then be analyzed and reported) by providing/exposing such attack vectors. Analysis tools within or associated with the local honeypot(s) provide pre-processing, analyze the collected traffic, e.g., based on its unique characteristics, origin points, the type of attack, and the like, and determine whether that traffic is indicative of a potential attack. If so, the honeypot summarizes a set of extracted data (e.g., attack vector, source IP range, timing information, impacted protocol, etc.) into an attack report.

In particular, and as will be described in detail below, each honeypot process executed in or in association with one or more edge servers within an edge server region is configured to perform honeypot-based continuous data capture, and pre-processing, and to provide the resulting information (sometimes referred to herein as “telemetry” or an “attack report”) to a central server. As used herein, a central server is configured as a single machine or group of server machines that have reliable and high-speed connectivity to the rest of the CDN edge regions. The central server(s) (also described herein sometimes as “central server infrastructure”) are configured to receive the telemetry (attack reporting) that is being continuously collected at the edge-local honeypot(s), and to process that information for formal attack detection and mitigation. In particular, and as will also be described, the central server infrastructure provides continuous data aggregation of the source telemetry (the attack reports) generated by the edge machines, and processes that information, e.g., by generating fingerprints of potential attacks, cross-correlating the fingerprints collected from the geographically-distributed edge server(s) or regions, and based on fingerprint (or other analysis), determine whether the geographically-collected telemetry (attack reporting) is representative of a true network attack, such as a DDoS. Because the telemetry is collected across a preferably wide set of distributed (geographically- and network-based) edge servers/regions, the central server provides an ability to identify a DDoS attack much faster and more reliably than known approaches. Based on a positive determination of a potential or actual DDoS attack in progress at some or all of the edge servers, the central server infrastructure is further configured to instantiate (trigger) one or more countermeasures, e.g., via targeted control signaling returned back to the attack source, or to associated network providers that can apply one or more countermeasures with respect to that attack source. The ability of the honeycomb defense network to identify the attack source and to facilitate the mitigation of the attack with respect to that source, sometimes referred to herein as “DDoS traceback,” provides further advantages.

In a preferred data collection approach, honeypots are configured in or in association with the edge servers across the overlay (or portions thereof). Honeypot data capture preferably is a continuous process. For each captured data packet, the honeypot process (or sub-process, as the case may be) extracts data, such as source IP address, destination IP address, port numbers, packet type (SYN, UDP, etc.), from data packet headers. In addition, the honeypot process may also analyze packet payload to facilitate identifying specific patterns or signatures representative of potential DDoS attack. The honeypot also records timestamps of the data capture that can be later used to correlate the information with potential attack telemetry information collected elsewhere, e.g., at other edge regions that may also be the target of (or otherwise impacted) by attack traffic. In addition, the honeypot may also extract information from the packets concerning the communication protocols being used (e.g., TCP, UDP, etc.). As the data is collected, the honeypot process also pre-processes the collected data, once again preferably on a continuous basis. To this end, the process analyzes the captured data to identify potential attack indicators, e.g., a sudden surge in traffic having a specific packet type. The analysis performed by honeypot process locally may leverage deterministic techniques, machine learning, or a combination thereof. If and when a potential attack is identified locally, and as noted above, the honeypot process summarizes the extracted data (attack vector, source IP range, timing information, communication protocols, etc.) and transmits it (as the telemetry) securely to the central server, which that information is compared with similar telemetry collected from other edge-based (local) sources.

At the central server infrastructure, the pre-processed attack data summaries provided from the geographically-distributed honeypots are received and stored. These attack reports are received continuously and stored in a scalable, highly-available, scalable data storage. Each entry (attack report) indexed into that storage is a possible new attack. For each new attack data entry, preferably the central server or servers combine telemetry (attack report) data from a current entry (which may or may not indicative of an active attack) with any relevant historical data, such as prior similar attack vectors, signatures, temporal data or the like, typically also from the same data source (the same local edge server or edge server region). Augmenting the attack data summary or summaries with potentially relevant historic or other “context” of this type enables the central server infrastructure to analyze the attack data summary in a more fine-grained manner, and thereby characterize the telemetry data according to one or more key characteristics. The characteristics include, without limitation, a DDoS attack vector (e.g., SYN flood, UDP flood, or the like), origin characteristics, e.g., source IP addresses (considering potential spoofing), network signatures (if available), and geo-location data (if available). The characteristics may also be behavioral in nature, e.g., timing patterns (representing sudden surges or otherwise atypical traffic scenarios), types of communication protocols used, and any other anomalies observed in the data. Based on the analysis (and some combination of some or all of these characteristics), the central server infrastructure then generates a unique attack fingerprint for this particular attack record for this particular edge server or servers from which the telemetry originated.

The central server infrastructure performs the above-identified analysis and fingerprint generation for other telemetry (attack report data) it receives from the other geographically-distributed edge server/region honeypots. Periodically, or asynchronously, the central server then compares the generated fingerprints using one or more fingerprint similarity metrics (as described in more detail below). By comparing fingerprints, the central server infrastructure identifies similar or identical attack vectors (as represented by their fingerprints) occurring across geographically-dispersed locations, similar source IP ranges or network signatures observed in geographically-distributed (distinct) honeypots indicating a potentially coordinated single attack, consistent communication protocols being used by botnets orchestrating the attack across distributed honeypots using a given command-and-control (CnC), and the like. By cross-correlating these information sources, the central server pinpoints a network or other network resource(s) that comprise an attack origination source. Once the attack original source is identified, distributed countermeasure triggering is initiated from the central server infrastructure. The triggering may be configured according to a network security policy. In one embodiment, the central server communicates with edge locations within the overlay network to signal affected (or potentially affected) edge servers with one or more mitigation strategies, such as rate limiting or blackhole malicious IP address(es) that the central server has identified from the cross-correlated attack fingerprints. Another mitigation strategy may involve reporting or otherwise sharing attack fingerprint data with the Internet Service Providers (ISP) responsible for the attack origination source. Such reporting facilitates the ISP taking self-help remediation efforts within their own network, e.g., to disrupt botnets or other compromised devices. More generally, the findings and recommendations made by the central server constitute threat intelligence data that is then stored, shared or otherwise re-used by other security players, systems, platforms, networks and devices.

The following describes a representative implementation of the honeycomb defense network described above. In this embodiment, the overlay network edge location may support compute resources (i.e., a GEC capability) in addition to the CDN services.

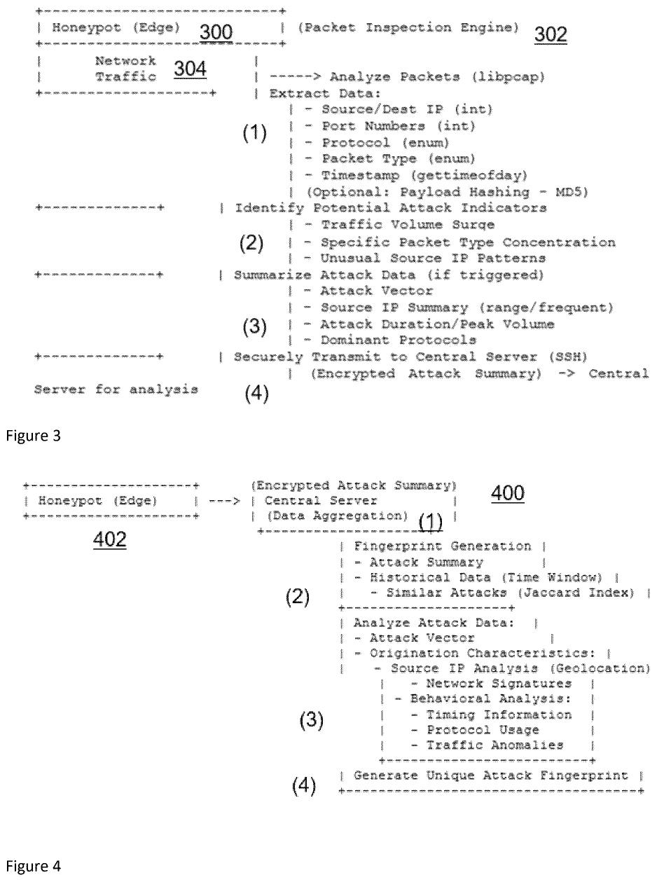

In particular, FIG. 3 depicts a honeypot process data capture (packet inspection) workflow in additional detail. As noted, preferably this workflow operates continuously at the honeypot process, typically, as computer software (program code) executing in one or more hardware processors. In one embodiment, the honeypot data capture leverages a lightweight packet inspection library (e.g., libpcap or the like) that is optimized for performance on what might otherwise be (when the honeypot executes on a GEC host) a resource-constrained honeypot virtual machine (VM). To this end, the Honeypot (Edge) 300 comprises a Packet Inspection Engine 302 (libpcap) that receives the Network Traffic 304 and performs the packet inspection against a set of configured data structures to efficiently capture and store relevant information from the packet headers, payloads (if available) or combinations thereof. This is step (1). As noted above, the packet header information typically includes source and destination IP addresses (preferably stored as integers for faster processing), protocol type (using one of a set of enumerated data types for efficiency), port numbers (stored as integers), packet type (SYN, ACK, ICMP), also preferably enumerated as one of a set of data types for efficiency), and the like. The packet inspection engines implements a timestamping mechanism, preferably using high-resolution timers (e.g., gettimeofday) to capture precise packet arrival times. If payloads are available (i.e., not otherwise encrypted or encoded), the engine defines a threshold for payload size to avoid capturing large amounts of data for irrelevant packets, and implements a hashing algorithm (e.g., MD5, SHA-1) to create a fingerprint of the payload for pattern matching. As FIG. 3 depicts, and at step (2), one or more potential attack indicators are then identified by the honeypot process, e.g., using one or more heuristics, lightweight machine learning, or the like. These include, for example but without limitation, traffic volume surges, specific packet type concentrations, usual source IP address patterns, and the like. If the processing indicates the possibility of an attack, then at step (3) the honeypot process is triggered to summarize the attack data, e.g., an identification of the potential attack vector, a source IP address summary (by range, frequency, or the like), attack duration/peak volume data, and an identification of the dominant protocols likely to be involved. This analysis may also leverage available local context information available to the packet engine workflow. At step (4), the honeypot process securely transmits the data summary (the attack record) to the central server infrastructure, e.g., using an SSH channel with public key authentication). The data summary may be further protected by an additional encoding or encryption wrapper, or by other known or cryptographic key methods and techniques.

The attack detection methods implemented by the honeypot process may vary. One preferred approach involves developing—in an off-line or pre-process manner—a set of heuristics for identifying potential attack indicators. To this end, historical data captured may be analyzed to define one or more baseline heuristics against which current data may then be compared to identify sudden traffic surges, abnormal or otherwise unexpected concentrations of packets (e.g., SYN packets for SYN flood attacks), unusual source IP patterns (e.g., a large number of packets from a single source), and the like. These heuristics also typically define thresholds for each indicator, e.g., based on empirical observations and possibly other threat intelligence. As an alternative to these heuristics, the historical data may be used to train a machine learning model or model(s) that are then used for follow-on inferencing against a current data set. As noted, if (applying the current data to the heuristics or other models) any one or more of the attack indicators are then triggered, the honeypot process summarizes the current captured data for transmission to the central server where it is aggregated and then analyzed. To this end, the honeypot process extracts an identified attack vector (e.g., SYN flood), summarizes the source IP addresses (e.g., range or most frequent source), computes an attack duration and peak traffic volume, and identifies one or more dominant communication protocols involved.

Different honeypot processes executing, for example, on or in association with distinct edge regions, may utilize the same or different attack detection methods. Because these processes comprise part of the same overall honeycomb defense network, the attack record(s) generated by distinct and geographically-disparate honeypots should still be configured to provide the central server with consistent attack reporting.

FIG. 4 depicts a representative set of operations that are carried out at the central server infrastructure 400. As noted above, preferably this infrastructure is conveniently located vis-h-vis the edge-based honeypots 402 so as to be able to act as a central location for the information data sets (attack reports) provided from those local data sources. A representative central server infrastructure comprises a set of interfaces, a scalable data storage, and associated services to provide a highly available, reliable and low-latent solution. For data storage, a distributed key-value store (e.g., Redis, PostgreSQL, or the like) may be used for efficient storage and retrieval of the attack data summaries that have been received from the geographically-distributed honeypots. This is step (1), sometimes referred to herein as data aggregation. Utilizing timestamps associated with each attack summary, the central server then maintains a chronological record of attack activity across the defense network. If the reports are delivered in an encrypted manner, the central server infrastructure implements a robust key management system to facilitate key generation, protection and management, to facilitate decryption of the attack records. Attack summaries are stored securely in the scalable database.

As also depicted in FIG. 4, the central server infrastructure is also configured to perform several additional functions, namely, fingerprint generation (step (2)), and attack data analysis (step (3)). Fingerprint generation involves several sub-steps, which are now described for a representative embodiment. In this example, a fingerprint generation algorithm combines data from a current attack summary with relevant historical data. In particular, and preferably based on attack type and possibly other available threat intelligence, a time window for considering the historical data (e.g., past hour, day or week, or the like) is defined. Utilizing one or more similarity metrics, such as a Jaccard index), the algorithm identifies one or more historically-similar attacks for context. The resulting data set, which represents the data from the current attack summary together with additional context, is then made available for attack data analysis. In this embodiment, the analysis then proceeds as follows to extract and analyze key characteristics for the fingerprint generation. To this end, the algorithm first identifies a primary attack method (vector) involved in the attack. This identification typically is based on the dominant packet type(s) involved together with the additional content data. The analysis then determines one or more attack origin characteristics, e.g., by analyzing source IP addresses for patterns, or using network signature databases to identify other characteristics of the attacker's network (if applicable to the current attack data). Thus, for example, if spoofing is suspected in the attack, the source IP address pattern analysis considers geographic distribution of source IPs and possibly network signatures for identifying the potential original. In addition, the analysis leverages IP geolocation techniques to estimate attack source location. After identifying the primary attack vector and the origination characteristics, a behavioral analysis is performed. This analysis may involve several operations, such as analyzing timing and volume information (calculate attack duration, peak traffic volume, etc.) against historical baselines, analyzing communication protocol usage patterns to identify potential botnet characteristics, and using other statistical or deterministic methods to identify anomalies in packet arrival time or traffic volume.

Based on the identified attack vector, the one or more attack origin characteristics, and the result(s) from the behavioral analysis, the central server applies a fingerprint generation function to generate a fingerprint for the particular attack record. This is step (4). In one example embodiment, the generation function is a hash function that combines these data points into a unique identifier, which is referred to herein as a unique attack fingerprint. In an alternative embodiment, the above-described attack analysis may be augmented with machine learning techniques for feature extraction and representation. The unique attack fingerprint is then saved into the scalable data storage in association with the attack record from which it was generated.

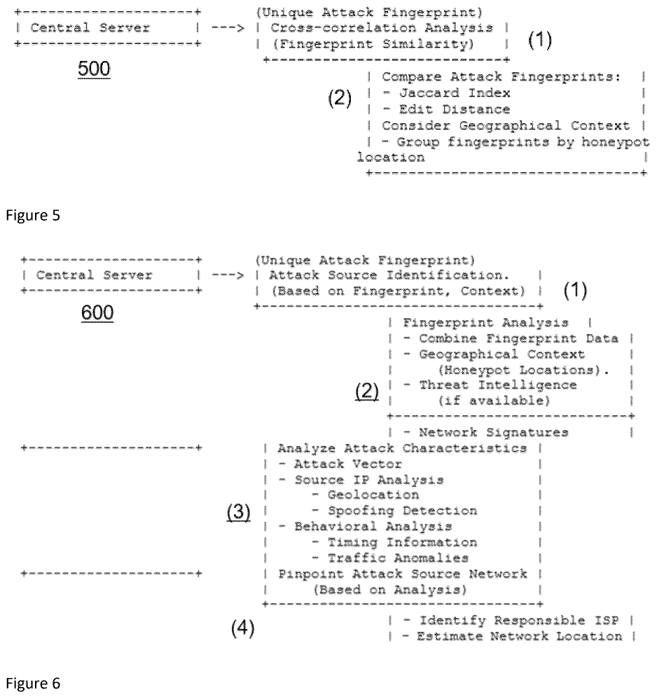

FIG. 5 depicts an example operation of the central server 500 after the fingerprint generation for the current attack record completes. This is sometimes referred to herein as a cross-correlation analysis. The purpose of this analysis is to enable the central server infrastructure to determine whether the attack records provided by geographically-dispersed honeypots are sufficiently correlated so as to identify or indicate a widespread attack. As used herein, the notion of a widespread attack refers to a DDoS attack that is identified (based on the attack records from multiple edge servers/regions) supplied to the central server, wherein preferably the attack is identified in substantially real-time. To this end, and as depicted in step (1), the cross-correlation analysis takes as input a given unique fingerprint (or fingerprint set), retrieves attack fingerprints from the data store, and implements a similarity comparison algorithm using one or more similarity metrics to determine whether unique fingerprint(s) are sufficiently correlated to reflect a single widespread attack. The similarity metrics include, e.g., a Jaccard index that, for at least first and second unique attack fingerprints, compares a ratio of shared characteristics to a total number of characteristics, edit distance, which measures a minimum number of edits (insertions, deletions, substitutions, etc.) needed to transform the first fingerprint into the second fingerprint, or vice versa, and combinations thereof. This is step (2). Based on a configurable threshold for fingerprint similarity and that distinguishes between random similarities and those that are meaningful (of a potentially coordinated attack), the cross-correlation outputs a determination whether the first and second unique fingerprints (that originate from attack records received from geographically-distinct honeypots) are sufficiently correlated so as to represent the same attack. A similar type of cross-correlation analysis is also done with respect to other fingerprints retrieved from the data store.

Preferably, and in addition to fingerprint similarity metrics, the cross-correlation analysis takes into consideration both geographical and temporal context, as geographically-dispersed honeypots with similar attack fingerprints, and/or fingerprints with similar timing patterns across geographically-dispersed locations typically are indicative of single source for a widespread DDoS attack. In an alternative embodiment, the geographic and/or temporal context is embedded in the fingerprint. Based on the combined analysis, the central server identifies a potential coordinated attack across the geographically-distinct overlay network locations. The central server issues appropriate alerts, e.g., to notify central security personnel for further investigation and potential mitigation actions (automated or otherwise).

Once the existence of the attack has been determined, the central server preferably then performs a traceback analysis to attempt to identify the attack source. This source may be a particular command and control (CnC) system, a network in which that system is operating, the identity of one or more devices or systems that have been compromised by the attack and that are being used to facilitate it further, and combinations thereof. Identification of the attack source may proceed as depicted in the workflow of FIG. 6. In this embodiment, the goal of this workflow is to pinpoint the potential attack source network (e.g., specific ISP or network range) at which the attack originates. The input to this process is the one or more unique attack fingerprint(s) that are identified by the cross-correlation analysis previously described. This is step (1). As previously noted, each such fingerprint typically includes relevant attack origin information, such as source IP address characteristics and behavioral patterns. As also noted, the central server also preferably incorporates geographical context information (i.e., the honeypot locations where similar fingerprints were detected. This information is then further augmented with available threat intelligence (e.g., external data feeds for insights into known malicious actors or attack sources), and available network signatures, which provide additional cues about the attacker's network characteristics. This is step (2). At step (3), the central server infrastructure performs an additional analysis based on the attack vector (the primary DDoS attack method employed), the source IP information (the source IP addresses within the fingerprint, further considering spoofing techniques and available geolocation IP address source data, and re-evaluation of behavioral factors, such as timing information (attack duration), attack volume (peak traffic, and any other traffic anomalies in light of the broader context. Based on this analysis, the central server determines the most likely source network responsible for the attack. This operation, step (4), may also involve estimating the location of the network and identifying the response ISP or other provider associated with that network.

Given the commonality of the information being analyzed the trackback operations described in FIG. 6 may be carried out in association with the central server operations depicted in FIG. 5.

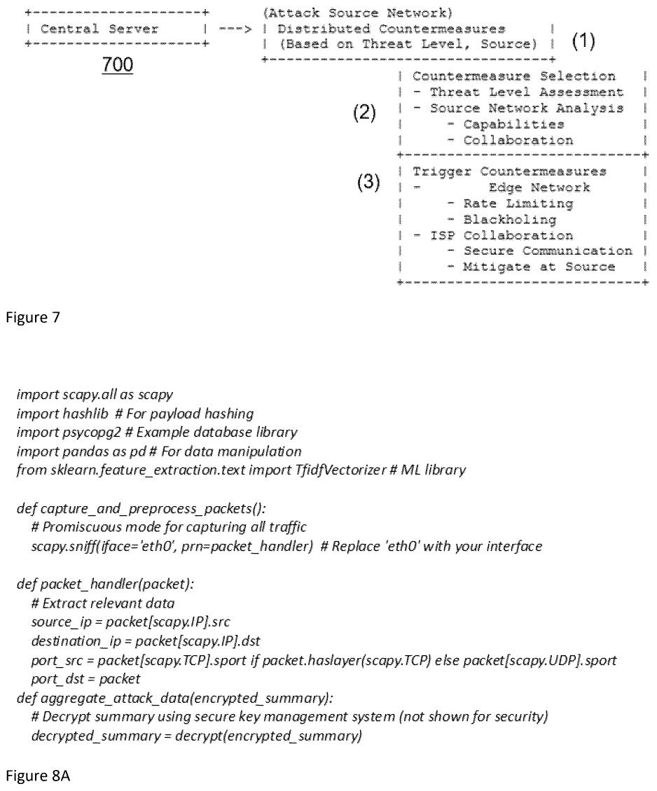

Once the attack source is identified, control continues as depicted in FIG. 7, wherein the central server 700 undertakes a set of (potentially) distributed countermeasures in an attempt to mitigate or otherwise ameliorate the attack. A representative workflow begins at step (1), with the identified source network responsible for the attack being the input. At step (2), one or more countermeasures are selected. Countermeasure selection may be based on a set of preconfigured templates (identifying a set of measures, their sequencing, and the like) that are then implemented, preferably via automated tooling or other interactions with control and notification infrastructure. In a preferred approach, countermeasure selection involves a threat level assessment that evaluates the severity of the attack, together with a further source network analysis that attempts to identify the capabilities of the source network (as well as its potential for collaboration). At step (3), once the countermeasures are selected, these measures are triggered by the control server. In the case of countermeasures that are available in the overlay network itself, the central server provides control signaling to one or more overlay network systems. This signaling may vary, but typically includes one or more of: instantiation of rate limiting controls at the edge networks to rate limit traffic from the attack source, instantiation of blackhole that blocks all traffic from the attack source network, and the like. In addition, the central server may also establish a secure communication channel with the responsible ISP and undertake collaborative effect to cause the ISP to take action within its network to disrupt the attack source directly. The collaboration may be set up in advance for this purpose. Preferably, interactions between the central server infrastructure and any such ISP or other service provider are carried out via automation or other tooling to ensure low latency.

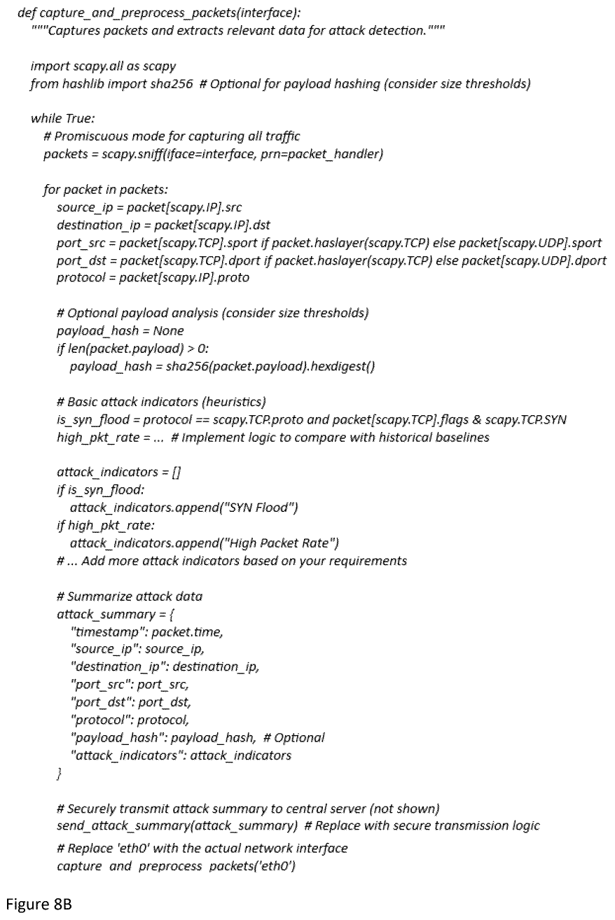

FIGS. 8A-8B depict a representative pseudocode implementation of the local honeypot data collection and pre-processing workflow.

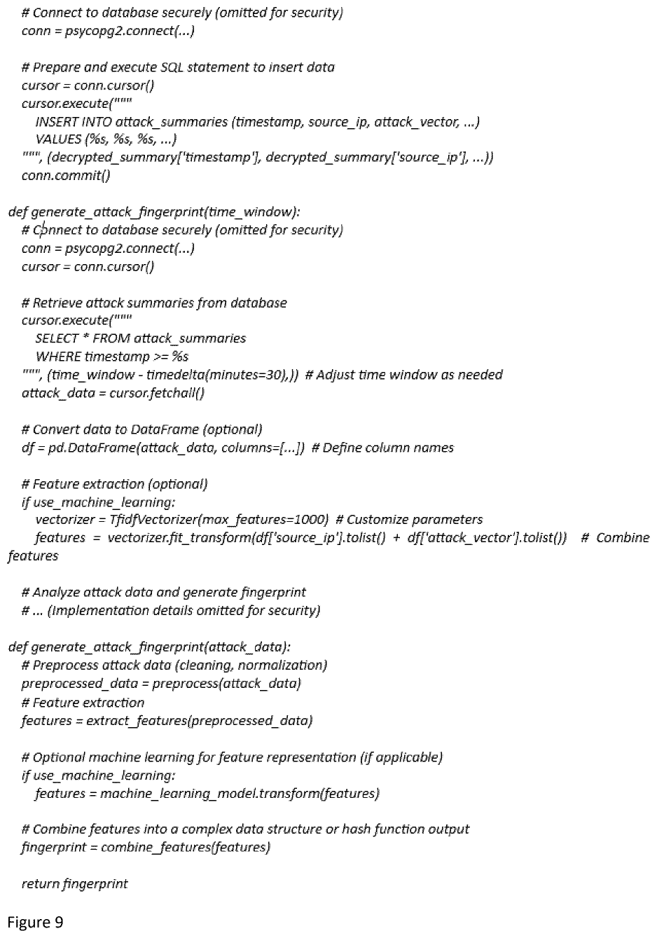

FIG. 9 depicts a representative pseudocode implementation of the fingerprint generation at the central server.

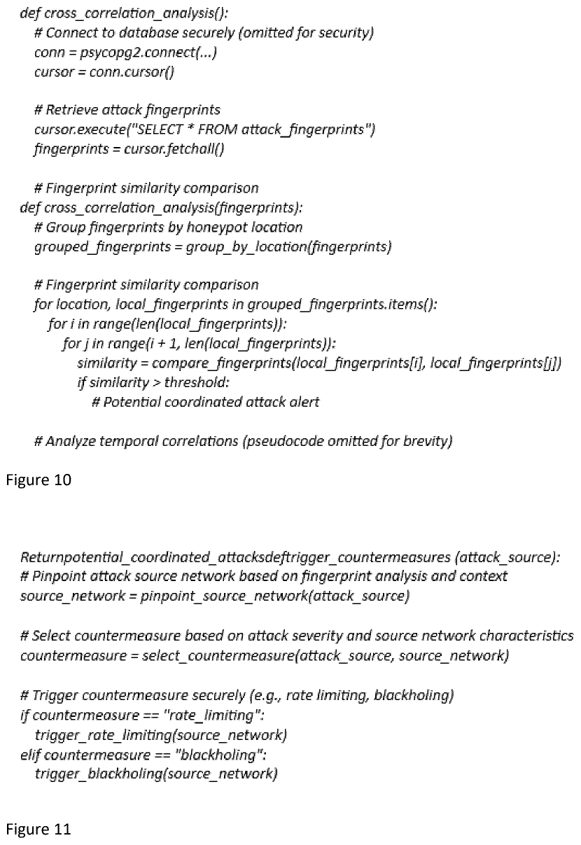

FIG. 10 depicts a representative pseudocode implementation of the fingerprint cross-correlation analysis at the central server.

FIG. 11 depicts a representative pseudocode implementation of the traceback and countermeasure selection at the central server.

### Enabling Technologies

The overlay network platform (such as depicted in FIG. 1) comprises a set of distributed technologies that are accessible, e.g., via a customer configuration portal.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines. The functionality may be provided as a service, e.g., as a SaaS solution.

The techniques herein may be implemented in a computing platform. One or more functions of the computing platform may be implemented conveniently in a cloud-based architecture. As is well-known, cloud computing is a model of service delivery for enabling on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Available services models that may be leveraged in whole or in part include Software as a Service (SaaS) (the provider's applications running on cloud infrastructure), Platform as a service (PaaS) (the customer deploys applications that may be created using provider tools onto the cloud infrastructure), and Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines.

The techniques herein may be implemented in any native code library, as a standalone process, or combinations thereof.

Each above-described process, module or functionality preferably is implemented in computer software as a set of program instructions executable in one or more processors, as a special-purpose machine.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be a particular machine that is specially constructed for the required purposes, or it may comprise a computer otherwise selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

A given implementation of the computing platform is software that executes on a hardware platform running an operating system such as Linux. A machine implementing the techniques herein comprises a hardware processor, and non-transitory computer memory holding computer program instructions that are executed by the processor to perform the above-described methods.

While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

Similarity metrics other than Jaccard distance may be used. Other metrics include, without limitation, Dice coefficient, Overlap coefficient, and Sorensen index. These metrics all focus on the overlap between two sets, but with variations in how they weight the overlap and non-overlap.

While the techniques herein have been described with respect to a network attack that is a Denial Distributed of Service (DDoS) attack, the methodology described herein involving the distributed honeypots, and the central server infrastructure, and the end-to-end data collection, attack detection, traceback and countermeasure mitigation are not limited to DDoS attack vectors. The nature of the “network attack” may vary and include, without limitation, attacks that occur at any level of the seven (7) layer OSI reference model.

The platform functionality (e.g., the central server infrastructure) may be co-located or various parts/components may be separately and run as distinct functions, perhaps in one or more locations (over a distributed network).

What is claimed follows below.

1. A method of protecting an overlay network against a network attack, comprising:
configuring a set of distributed honeypots at geographically-distributed servers of the overlay network, wherein a given honeypot is configured to mimic one or more vulnerabilities;
at a central server infrastructure:
continuously receiving attack summary reports from the set of distributed honeypots, an attack summary report having been generated at a given distributed honeypot;
generating a unique attack fingerprint for each attack summary report;
determining whether the unique attack fingerprint for a first attack summary report has a given relationship with the unique attack fingerprint for a second attack summary report, wherein the first and second attack summary reports originate within a given common time window and from honeypots at respective first and second geographically-distributed servers of the overlay network;
upon a determination that the first attack summary report has the given relationship with the unique attack fingerprint for a second attack, generating an output indicating the network attack;
responsive to generating the output, performing a traceback analysis to identify an attack source; and
responsive to identifying the attack source, identifying and initiating a set of one or more countermeasures configured to mitigate the network attack.

2. The method as described in claim 1, wherein the network attack is a Distributed Denial of Service (DDoS) attack.

3. The method as described in claim 1, wherein an attack summary record comprises information computed at a honeypot, the information being one of: an identified attack vector, a source IP address frequency or range associated with the attack, an attack duration, a volume of traffic associated with the attack, a dominant communication protocol used in the attack, and combinations thereof.

4. The method as described in claim 1, wherein generating the unique attack fingerprint includes defining a time window for analysis, and extracting a set of characteristics during that time window, the set of characteristics including a primary attack vector, one or more origin characteristics, and one or more behavioral characteristics.

5. The method as described in claim 4, further including applying a given function to the set of characteristics to generate the unique attack fingerprint.

6. The method as described in claim 5, wherein the given function is a hash function.

7. The method as described in claim 1, wherein the given relationship is based on a similarity metric that is one of: a Jaccard distance, and an edit distance.

8. The method as described in claim 1, wherein the trackback analysis is based on attack source information derived from a unique attack fingerprint and other information.

9. The method as described in claim 8, wherein the other information is one of: threat intelligence data, and network signature data.

10. The method as described in claim 1, wherein the set of one or more countermeasures are implemented in an automated manner.

11. The method as described in claim 1, wherein the overlay network is a Content Delivery Network (CDN).

12. The method as described in claim 1, wherein the one or more vulnerabilities are one of: network protocol vulnerabilities, application layer vulnerabilities DNS amplification vulnerabilities, weak security configurations smurf attacks, reflective attacks, and combinations thereof.

13. The method as described in claim 1, wherein the set of one or more countermeasures are implemented in one of: the overlay network, and an external network.

14. The method as described in claim 1, wherein the set of one or more countermeasures are identified and initiated in real-time as the network attack proceeds.

15. The method as described in claim 1, wherein the central server infrastructure receives the attack summary reports over secure communication channels.

16. The method as described in claim 1, wherein a honeypot is configured in association with one of: an edge server of the overlay network, and a compute host of the overlay network.
